(19) United States
(12) Patent Application Publication
(10) Pub. No.: US 2007/0153394 A1
(43) Pub. Date: Jul. 5, 2007

(54) Microlens array

(75) Inventor: Makoto Soyama, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/648,980

(22) Filed: Jan. 3, 2007

Related U.S. Application Data
(60) Provisional application No. 60/756,367, filed on Jan. 5, 2006.

(51) Int. Cl. G02B 27/10

(52) U.S. Cl. 359/620

(57) ABSTRACT

A microlens array includes a plurality of microlens arranged in a matrix. An angle between a lens surface and a bottom surface of the microlens is 65 degrees-80 degrees. The boundary between adjacent microlenses may have an undulation on a surface vertical to an optical axis direction. Each of the boundaries may have a portion in which an angle between the lens surface and the bottom surface of the microlens is 65 degrees-80 degrees. A horizontal or vertical boundary in the microlens may have an undulation on a surface vertical to an optical axis.

### BACKGROUND

1. Field of the Invention

The present invention relates to a microlens array. Particularly, the present invention relates to a microlens array in which a plurality of single lenses are arranged in a plane, which is used for a transmissive screen.

2. Related Art

As a transmissive screen used as a rear projection screen for example, a screen formed by which a front plate for protecting a lens, a lenticular lens sheet or a lens array sheet, and a Fresnel lens sheet are laminated sequentially from an observer side has been known. Here, the lenticular lens sheet has a plurality of cylindrical lenses on either or both of the light incident side and the light outgoing side. Meanwhile, the lens array sheet has a microlens array in which a plurality of microlenses are arranged over the light incident side. Both of them serves to extend the viewing angle in a horizontal direction and a vertical direction at the observer side.

FIG. 1 shows a microlens array 100 formed on the surface of a lens array sheet. As shown in FIG. 1, the microlens array l00 includes a plurality of microlenses 200 which are arranged in a matrix in a plane in the horizontal direction (“X” direction in FIG. 1) and the vertical direction (“Y” direction in FIG. 1) on the light incident side. FIG. 2 is a perspective view showing a typical microlens 200. FIG. 3 is a top view showing the microlens 200 shown in FIG. 2. FIG. 4(A) is a cross-sectional view of FIG. 3 cut by a-a′ line. FIG. 4(B) is a cross-sectional view of FIG. 3 cut by b-b′ line.

As shown in FIG. 2-FIG. 4, the microlens 200 has a shape obtained by cutting a lens surface 250 formed on the light incident side, which is a curved surface with an even curvature by a short edge 210 and a long edge 220, respectively. each of the short edge 210 and the long edge 220 is a boundary between adjacent microlenses 200 in the microlens array 100. In the microlens array 100 in which the microlenses 200 having such shape are arranged in a matrix in a plane, the brightness is rapidly reduced in the vicinity of the limit viewing angle in the vertical direction, i.e. cutoff will be occurred.

If such cutoff is occurred, an observer may perceive uneven brightness on the screen, so it become a practical problem. In order to reduce such cutoff, a lenticular lens sheet having a cylindrical lens of which shape of cross section is a high-order aspheric surface is disclosed as, for example, in Japanese Patent Application Publication No. 2002-169228.

On the other hand, it is expected that the use of lens array sheet is increased along with popularizing a high-definition transmissive screen, however, any effective method of reducing the above-described cutoff has not been proposed.

### SUMMARY

To solve the above described problems, a first aspect of the present invention provides a microlens array including a plurality of microlenses arranged in a matrix in a plane. An angle between the lens surface and the bottom surface of a lens on a lens boundary is 65 degree-80 degree. Thereby any cutoff can be reduced in a transmissive screen using such microlens array.

A second aspect of the present invention provides a microlens array. In the microlens array, the angle between the lens surface and the bottom surface of a lens on a lens boundary is 70 degree-75 degree. Thereby any cutoff can be more effectively reduced in a transmissive screen using such microlens array.

A third aspect of the present invention provides a microlens array including a plurality of microlenses arranged in a matrix in a plane. The boundary between adjacent lenses has undulation on the surface vertical to the optical axis direction. Thereby any cutoff can be reduced in a transmissive screen using such microlens array.

In the microlens array, each boundary may have a portion in which an angle between the lens surface and the bottom surface of a lens on a lens boundary is 65 degree-80 degree. Thereby any cutoff can be more effectively reduced in a transmissive screen using such microlens array.

In the microlens array, the horizontal boundary and the vertical boundary may be undulated on the surface vertical to the optical axis direction. Thereby any cutoff in both of the horizontal direction and the vertical direction can be reduced in the transmissive screen using such microlens array.

Here, all necessary features of the present invention are not listed in the summary of the invention. The sub-combinations of the features may become the invention.

### BRIEF DESCRIPTION OF THE DRAWINGS

FIG. 1 shows a microlens array 100 formed on the surface of a lens array sheet;

FIG. 2 is a perspective view showing a typical microlens 200;

FIG. 3 is a top view showing the microlens 200 shown in FIG. 2;

FIG. 4A is a cross-sectional view of FIG. 3 cut by a-a′ line, and FIG. 4B is a cross-sectional view of FIG. 3 cut by b-b′ line;

FIG. 5 is a perspective view showing a microlens 300 according to an embodiment;

FIG. 6 is a top view showing the microlens 300 shown in FIG. 5;

FIG. 7C is a cross-sectional view of FIG. 6 cut by c-c′ line, and FIG. 7D is a cross-sectional view of FIG. 6 cut by d-d′ line;

FIG. 8 is perspective view showing a microlens 400 according to another embodiment;

FIG. 9 is a top view showing the microlens 400 shown in FIG. 8; and

FIG. 10E is a cross-sectional view of FIG. 9 cut by e-e′ line, FIG. 10F is a cross-sectional view of FIG. 9 cut by f-f′ line, FIG. 10G is a cross-sectional view of FIG. 9 cut by g-g′ line, FIG. 10H is a cross-sectional view of FIG. 9 cut by h-h′ line and FIG. 10I is a cross-sectional view of FIG. 9 cut by i-i′ line.

### DESCRIPTION OF EXEMPLARY EMBODIMENTS

Hereinafter, the present invention will now be described through preferred embodiments. The embodiments do not limit the invention according to claims and all combinations of the features described in the embodiments are not necessarily essential to means for solving the problems of the invention.

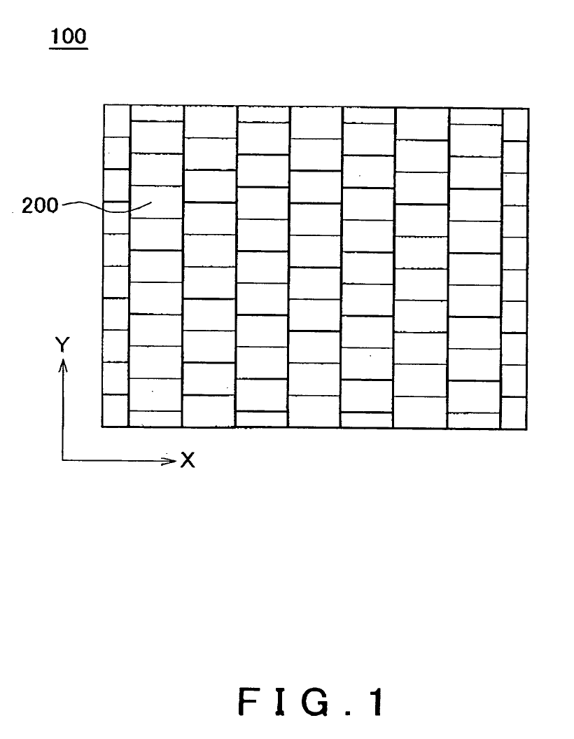

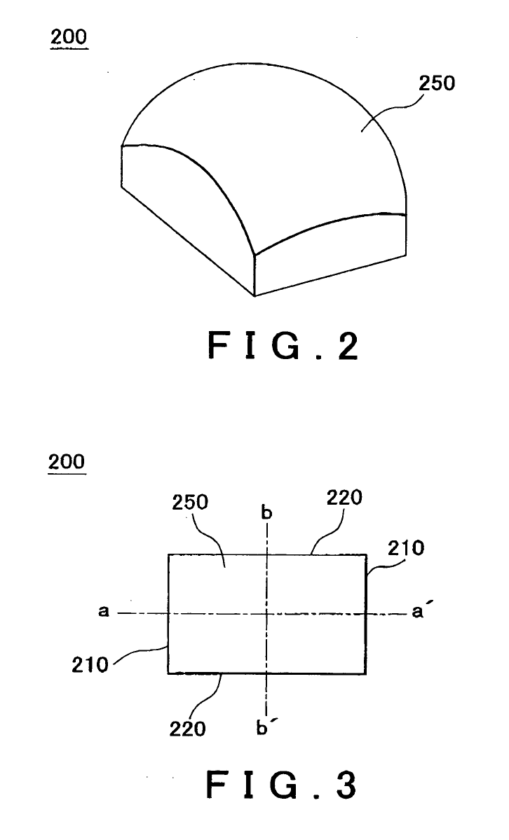

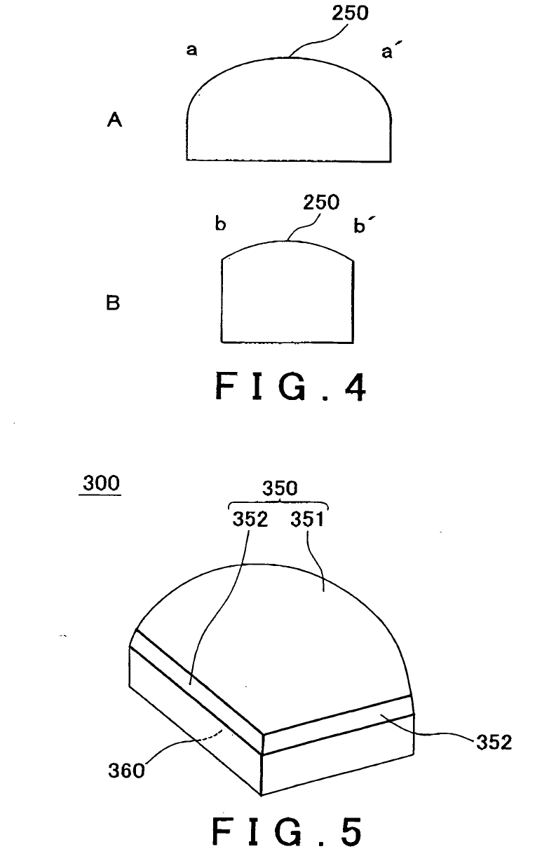

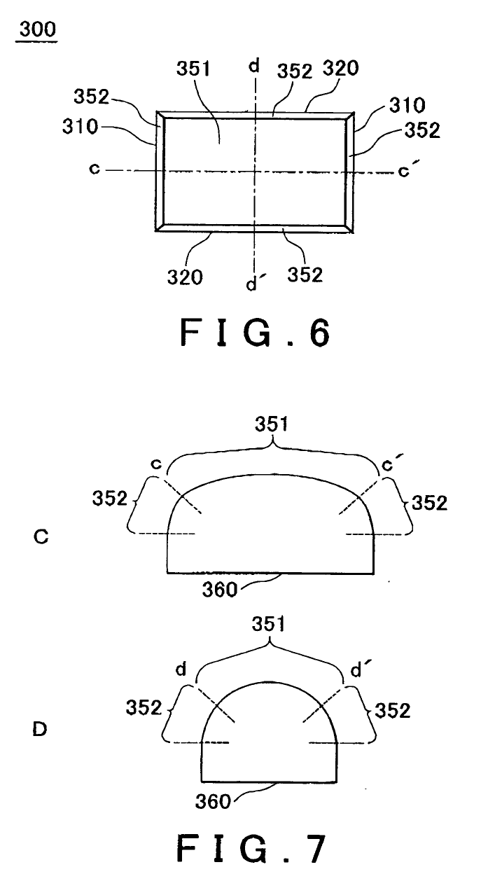

FIG. 5 is a perspective view showing a microlens 300 according to the present embodiment. A plurality of microlenses 300 shown in FIG. 5 are arranged in a matrix in a plane on the light incident side of the microlens array 100 shown in FIG. 1. FIG. 6 is a top view showing the microlens 300 shown in FIG. 5. As shown in FIG. 5 and FIG. 6, the microlens 300 has a lens surface 350 which is a curved surface formed on the light incident side. The shape of the microlens 300 is obtained by cutting the lens surface 350 by the short edge 310 and the long edge 320 shown in FIG. 6, respectively. Each of the short edge 310 and the long edge 320 of the microlens 300 is a boundary between a microlens 300 and the adjacent microlens 300 in the microlens array 100. The lens surface 350 of the microlens 300 has a first curved portion 351 at the center portion thereof, and a second curved surface 352 outside of the first curved portion 351.

FIG. 7C is a cross-sectional view of FIG. 6 cut by c-c′ line, and FIG. 7D is a cross-sectional view of FIG. 6 cut by d-d′ line. The shape of the first curved surface 351 is determined dependent on the optical characteristic for the whole of the microlens array 100 including each microlens 300, such as the range of diffusion and the distribution. In this case, when an angle between the tangent line of the outmost second curved section 352 and a lens bottom surface 360 is large, the cutoff can be reduced. According to the present embodiment, it is preferred that the above-described angle is 65 degree-80 degree, and it is more preferred that the angle is 70 degree-75 degree. Thereby the boundary between the adjacent second curbed portions 352 is formed such that the boundary between the second curved portions 352 of the adjacent microlenses 300 is curved along the side of the lens bottom surface 360 than the border between the extended lines of the first curved lines 351 which are crossed. It is preferred that the boundary between the first curved surfaces 315 and the second curved surfaces 352 are a smooth curved surface. However, a shape of the boundary is not limited to that but the second curved surface 352 may be a flat surface. Additionally, a binary lens having a plurality of irregularities by such as a laser abrasion is applicable instead of the curved surface.

In the microlens 300 having the shape shown in FIG. 5-FIG. 7, the brightness is not rapidly reduced in the vicinity of the limit viewing angle particularly in a vertical direction. Therefore, any cutoff does not easily occur in a transmissive screen using the microlens array 100 in which such microlenses 300 are arranged in a matrix in a plane on the light incident side.

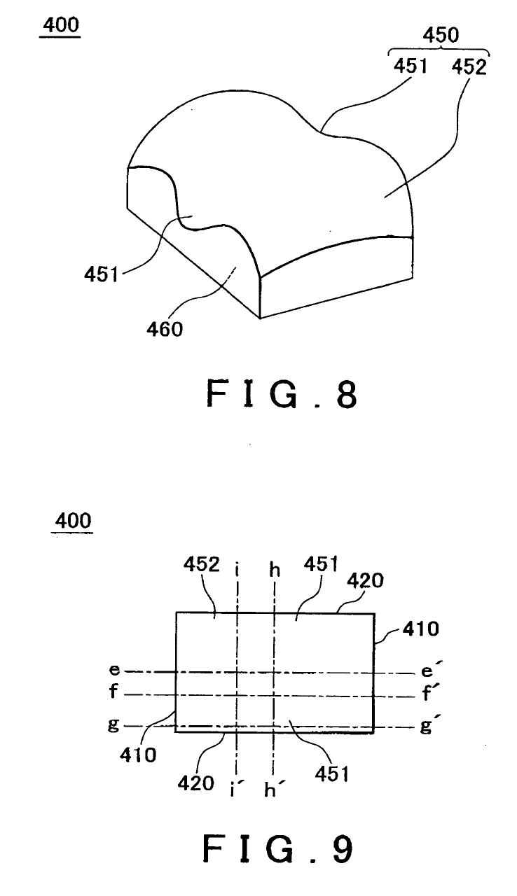

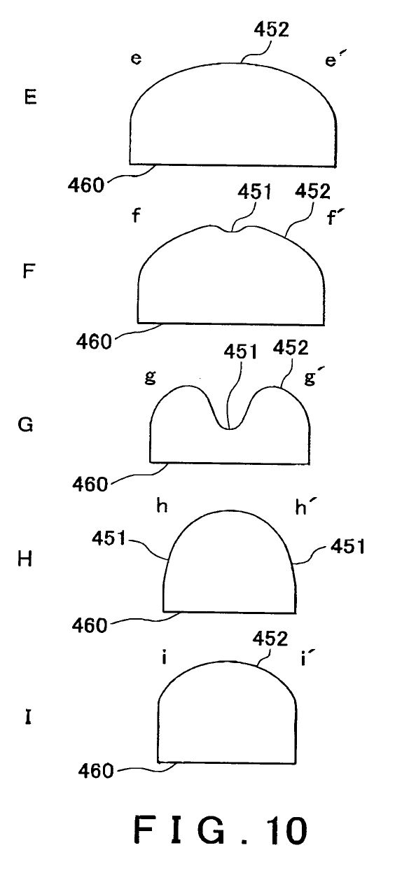

FIG. 8 is perspective view showing a microlens 400 according to another embodiment. A plurality of the microlens 400 shown in FIG. 8 are arranged in a matrix in a plane on the light incident side of the microlens 100 as well as the microlenses 200 and the microlenses 300. FIG. 9 is a top view showing the microlens 400 shown in FIG. 8. As shown in FIG. 8 and FIG. 9, each of the short edge 410 and the long edge 420 of the microlens 460 is a boudary between a microlens 400 and the adjacent microlens 400 in the microlens array 100 as well as the microlens 200 and the micro lens 300. FIG. 10E is a cross-sectional view of FIG. 9 cut by e-e′ line, FIG. 10F is a cross-sectional view of FIG. 9 cut by f-f′ line, FIG. 10G is a cross-sectional view of FIG. 9 cut by g-g′ line, FIG. 10H is a cross-sectional view of FIG. 9 cut by h-h′ line and FIG. 10I is a cross-sectional view of FIG. 9 cut by i-i′ line.

As shown in FIG. 8-FIG. 10, the microlens 400 has an undulation portion 451 which undulates on a surface vertical to the optical axis direction from the center of a lens surface 450 to the long edge 420. The curvature of a curved surface obtained by cutting the microlens 400 at the center of the undulation portion 451 in the vertical direction is larger than the curvature of a curved surface section 452 except for the undulation portion 451 of the lens surface 450 as shown in FIG. 10H and FIG. 10I. Accordingly, the shape of the microlens 400 is such that the bottom of the undulation portion 451 is closer to the lens bottom surface 460 than the curved portion 452 in the vicinity of the long edge 420 which is a boundary between microlenses 400 adjacent each other. Here, an angle between the undulation portion 451 and the lens bottom surface 460 in the vicinity of the long edge 420 which is the boundary between the adjacent microlenses 400 is 65 degree-80 degree.

In the microlens 400 having the shape shown in FIG. 8-FIG. 10, an incident light from the lens surface 450 in the vertical direction exits from the lens bottom surface 460 more dispersingly than the case of the microlens 200. Accordingly, the limit viewing angle in the vertical direction is dispersed, so that the brightness can be prevented from rapidly reducing in the vicinity of a specified angle. Therefore, any cutoff does not easily occur in a transmissive screen using the microlens array 100 in which such microlenses 400 are arranged in a matrix in a plane on the light incident side.

Additionally, the lens surface 450 may have an undulation portion 451 also in a horizontal direction. Thereby any cutoff does not easily occur in both of the horizontal direction and the vertical direction using the microlens array 100 in which such microlenses 400 are arranged in a matrix in a plane on the light incident side.

In the present embodiment, it is preferred that a material of the microlens array can transmit at least visible light, and its refractive index is within 1.4-1.65. For example, the material can be selected among well-known thermosetting resin, photo-curable resin, thermoplastic resin and glass. Here, the microlens array 100 may be manufactured by a method of filling a female die on which the pattern of the microlens array 100 is applied with resin, or a method of transferring the material filled in the female die on the base material. Additionally, the microlens array l00 also may be manufactured by a method including the steps of: applying evenly a photo-curable resin such as a UV-curable resin on a base material; irradiating light on a part on which a lens is formed to be cured the same; and removing the unnecessary portion, a method of shaping the microlens array 100 by mechanically cutting the surface of the base material and the combination thereof.

Still more, the shape of the bottom surface of each of the microlens 200 and the microlens 300 is quadrangle in the present embodiment. However, the shape of the bottom surface of each of the microlens 200 and the microlens 300 is not limited to that. For example, it may be hexagon. Additionally, the size and the shape of a plurality of microlenses 200 and 300 may not be the same. The microlenses 200 and 300 having various size and shape may be regularly or irregularly arranged.

While the present invention has been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

1. A microlens array comprising a plurality of microlenses arranged in a matrix in a plane, wherein an angle between a lens surface and a bottom surface of a microlens on a lens boundary is 65 degrees-80 degrees.

2. A microlens array comprising an angle between a lens surface and a bottom surface of a microlens on a lens boundary is 70 degrees-75 degrees.

3. A microlens array comprising a plurality of microlenses arranged in a matrix in a plane, wherein the boundary between adjacent microlenses has an undulation on a surface vertical to an optical axis direction.

4. The microlens array as set forth in claim 3, wherein each of the boundaries has a portion in which an angle between the lens surface and the bottom surface of the microlens is 65 degrees-80 degrees.

5. The microlens array as set forth in claim 3, wherein a horizontal or vertical boundary in the microlens has an undulation on a surface vertical to an optical axis.

6. The microlens array as set forth in claim 4, wherein a horizontal or vertical boundary in the microlens has an undulation on a surface vertical to an optical axis.
